(19) United States
(12) Patent Application Publication
(10) Pub. No.: US 2012/0182605 A1
(43) Pub. Date: Jul. 19, 2012

(54) Identification Device

(75) Inventors: Loftus Richard Hall, Hackney (GB); Ross James McSherry, High Hurstwood (GB); Eoin Seiorse O'Keefe, Gosport (GB)

(73) Assignee: QINETIQ LIMITED, Farnborough, Hampshire (UK)

(21) Appl. No.: 13/498,193

(22) PCT Filed: Oct. 22, 2010
(86) PCT No.: PCT/GB2010/001960

§ 371 Date: Mar. 26, 2012

(30) Foreign Application Priority Data
Oct. 23, 2009 (GB) 0918720.4

(51) Int. Cl. G02B 5/09; B31B 1/26

(52) U.S. Cl. 359/350; 493/405

(57) ABSTRACT

The invention relates generally to passive infrared markers and especially to markers which are reflective in the thermal and/or near infrared wavebands. A thermal infrared marker device is provided taking the form of a truncated pyramid, preferably a hollow truncated pyramid, said device comprising n side facets, where n≧3, and a top facet (13), wherein two or more side facets comprise a thermally reflective material (17). The device may take the form of a foldable blank comprising mutually engageable side facets (21), optional fold lines (14) and mutual attachment means (15). The invention has particular utility in military applications.

The invention relates generally to passive infrared markers and especially to markers which are reflective in the thermal and/or near infrared wavebands. The invention also relates to an infrared marking system and a method of using the infrared marker.

It is known to use panels that are reflective in the thermal infrared—commonly known as thermal identification panels—as identification markings in military operations. Such panels can help to prevent accidental targeting of friendly forces through thermal infrared sights, but are only effective if used and/or applied in the correct manner.

A thermal identification panel acts as a marker by providing a region of high thermal infrared emittance contrast on a surface. The region is created by minimising the self-emittance of thermal infrared radiation and the reflected thermal infrared energy of the panel, so as to create an ‘apparently cold’ area, while areas adjacent to the panel have high self emittance and are ‘apparently hot’. Minimisation of the reflected energy component of the panel is typically achieved by means of the so-called ‘cold sky reflection’ phenomenon, which exploits the fact that some parts of the sky are cold and emit little thermal infrared radiation (see, for example, O'Keefe et al, “Infrared and visible combat identification marking materials”, Proc. of SPIE Vol. 6538, 6538Y-1 to 6538Y-12). If the panel is oriented to reflect the cold sky into the thermal sight, the desired thermal contrast can be achieved.

One known thermal identification panel takes the form of a flexible sheet of square fabric having a size of about 1 m², one side of which is highly reflective in the thermal infrared and the other visually distinctive (for example, brightly coloured). The thermally reflective side of the panel may comprise an additional visually camouflaged layer. In use, the thermal identification panel is positioned on or near the top surface of a structure or vehicle at a specified angle, which angle is typically achieved by draping and tensioning the sheet over a box-shaped temporary or permanent feature. When positioned correctly, the panel can help to identify the structure or vehicle from ground-to-ground observation and/or air-to-ground observation. Often, however, the thermal identification panel is incorrectly or poorly installed and, as a result, is less visible than intended from the side (ground-to-ground observation) and/or from a near horizon air approach (air-to-ground observation). Other problems include; insufficient fixing points to create the sloping edges, the ad hoc nature of the support feature leading to a wide range of shapes and sizes, and wrinkles on the fabric reflector surface (thereby reducing the intensity of the reflected signal compared with a plane smooth surface of the same area).

U.S. Pat. No. 5,567,950 discloses a rigid, dihedral shaped device which uses the principle of cold sky reflection to mark a location for a thermal imaging device. However, the device is designed to be a lane marker for an approaching plane or land vehicle and provides a narrow observation corridor. Accordingly, the device is unsuitable for use as a ‘friend from foe’ infrared marker, which needs to be visible from many directions. Similarly, WO 2005/110011 discloses an infrared reflective marking system taking the form of an inverted V-shape which can be used to mark a landing zone.

Other examples of devices intended for aircraft landing applications included U.S. Pat. No. 5,115,343 and U.S. Pat. No. 2,330,096. In both cases, the reflective surfaces are retro-reflecting (that is, light is reflected back in the incident direction). Such devices are not suitable as ‘cold sky’ markers. EP 0218771 is an example of a visible marker taking the form of a trilateral hollow pyramid.

Thus, there exists a need for an improved thermal identification panel which can be installed reliably during military operations.

According to a first aspect of the invention, there is provided an infrared marker device taking the form of a foldable blank comprising a plurality of facets and fold lines between adjacent facets, said blank being capable of forming a hollow pyramid structure, wherein the plurality of facets includes n side facets (where n≧3) and wherein at least one pair of mutually engageable side facets comprise mutual attachment means so that the pyramid structure can be formed and wherein two or more side facets comprise a thermally reflective material. By adjacent facets is meant facets that are joined together in the blank. By mutually engageable pair of side facets is meant a pair of side facets which are not joined together in the blank (that is, in two dimensions) but which require mutual engagement to form the three-dimensional pyramid structure.

Thermal identification panels that rely on the principle of ‘cold sky reflection’ are well known. Typically, a material having low thermal emissivity and high thermal reflectance is inclined at an angle of between 20° and 60° to the horizontal, so that thermal radiation from the cold part of the sky near the horizon is reflected into a ground- or air-based thermal imager. The panel is seen as a ‘cold’ (dark in white hot polarity and white when in black hot polarity) spot in the imager. The inventors have found that it is possible to obtain a thermal image visible from many directions by providing a thermal identification marker having two or more thermally reflective surfaces. The required inclination angle for the thermally reflective surfaces (20° to 60°) can be achieved in a three-dimensional shape by providing a marker having a pyramidal shape, preferably a truncated pyramid. A truncated tetrahedron or a truncated square based pyramid give particularly good angular coverage and hence, conspicuity. Preferably, all surfaces of the pyramid are thermally reflective.

However, a marker device taking the form of a permanently assembled pyramid poses significant logistical problems in scenarios such as on a battlefield, where a device is required which can be readily deployed when needed, but which can also be stowed in a compact space when not in use. Accordingly, the device instead takes the form of a foldable blank which can be readily assembled into a pyramid shape and subsequently collapsed for storage. Moreover, the device can—if required—be used in a collapsed form to provide an infrared signature on a horizontal surface. An important advantage over prior art collapsible markers (such as the flexible sheet thermal identification panel described above) is that the device of the invention is capable of folding for storage, yet can also be easily and rapidly assembled into a device having smooth reflective surfaces, regular appearance and the correct reflection angles.

The blank comprises a plurality of facets and fold lines between adjacent facets, and is capable of forming a hollow pyramid structure having at least three sides. The blank can be any two-dimensional net shape of the desired three-dimensional pyramid, and the skilled person will be aware of many possible net shapes. However, certain net shapes provide particular advantages for the marker device of the invention. For example, it is particularly beneficial for the blank to have a shape wherein adjacent facets are joined together consecutively, so as to form a single chain of adjacent facets. This allows the blank to be folded for stowage in a zig-zag or fan-fold fashion (that is, whereby consecutive pairs of facets are folded over each other in opposite directions about their respective fold lines) resulting in a stowable structure which is compact and flat. Optionally, mutual locking means (such as, for example, a clip, hook and loop fasteners, snap lock fasteners or ropes) can be positioned on the first and/or last facet in the chain of facets so as to keep the structure flat once folded.

The device is assembled for use by folding the blank along the fold lines so as to bring the plurality of facets into correct three-dimensional alignment, and the at least one pair of mutually engageable side facets are then secured in place by mutual attachment means positioned thereon. The precise number of pairs of mutually engageable side facets (and hence, mutual attachment means) depends upon the net shape of the blank; some net shapes, for example, may have just one pair of mutually engageable side facets in the two-dimensional form, whereas other net shapes may have two or more pairs of mutually engageable side facets in two dimensions. Typically, a pair of mutually engageable side facets forms one corner of the pyramid structure once the device is assembled.

Once assembled, the device takes the form of a hollow pyramid comprising n side facets (where n≧3). Two or more side facets comprise a thermally reflective material, so that the device is visible from two or more sideways directions. Preferably, all of the side facets comprise a thermally reflective material, so that the device is conspicuous from all sideways observation angles (in other words, so as to provide multi-directional functionality).

The pyramid structure provides optimum conspicuity. This contrasts with prior art devices taking the form of a flexible sheet, where the shape is non-optimised and tends to be entirely dependant on available surfaces on the object to be marked. Further advantages of the invention include those mentioned above; rapid and straight forward deployment, ability to use the device on a variety of different objects and/or in a variety of different locations, smooth infrared reflective surfaces and regularity of appearance. All of the aforementioned advantages lead to more reliable marker recognition.

The side facets are preferably substantially the same size and shape, so as to form a regular pyramid structure such as, for example, a square-based pyramid. Alternatively—where n is an even number—opposing facets may be the same size and shape, thereby forming an elongated pyramid structure such as, for example, a rectangle-based pyramid.

Preferably, the pyramid structure is a truncated pyramid and the side facets each comprise a top edge, a bottom edge and two lateral edges. The truncated pyramid can be either a capped or uncapped structure. If a capped structure is desired, the blank can additionally comprise a top facet. An infrared marker device comprising a top facet (which preferably also comprises an infrared reflective material) is desirable so that the device can be seen from above (air-to-ground observation) as well as from the ground, resulting in an uninterrupted hemispherical detection arc. If required, top facet fastening means can be provided on one or more of the top edges of the side facets and/or one or more edges of the top facet so as to secure the top facet in place. This ensures that the top facet is held at the correct angle (typically parallel to a plane parallel to the base of the pyramid) and can also impart extra rigidity to the assembled pyramid structure. The top facet fastening means may be any suitable fastener, preferably selected from the group consisting of zips, press studs, snap fasteners, hook and loop fasteners, buttons, buckles and eyelets. Typically, the top facet takes the size and shape of the opening formed by the top edges of the side facets when the device is assembled, although the top facet may be slightly smaller than said opening to accommodate the top facet fastening means.

The pyramid can—in theory—comprise any number of sides, but in practice there tends to be an optimum number of sides for any particular application. In general, structures having more sides are advantageous because they can be visible from more directions. However, the reflection area per facet (and hence, marker efficiency) generally decreases as the number of side facets increase. It has been found that optimum marker efficiency and adequate directionality can be obtained for devices where the number of side facets (n) lies in the range 3 to 10, more preferably in the range 3 to 8 and even more preferably in the range 3 to 6. Most preferably n=3, 4 or 5 so as to form—respectively—a triangle based pyramid, a square or rectangle based pyramid or a pentagon based pyramid. The aforementioned preferred ranges apply to both truncated and non-truncated structures.

It follows that the most preferred truncated pyramid structures are a truncated triangle based pyramid (n=3), a truncated square based pyramid or rectangle based pyramid (n=4) or a truncated pentagon based pyramid (n=5). A truncated pyramid is generally preferred to a non-truncated pyramid.

By facet is meant a plate, sheet, panel or suchlike which, upon assembly, forms a face of the hollow pyramid structure. The side facets, and optional top facet, are preferably formed from a rigid or semi-rigid material, but may also comprise a locally stiffened flexible material which nevertheless has sufficient rigidity once the device is assembled. An example of a locally stiffened flexible material is a fabric having an internal skeleton or framework, Conveniently—but not necessarily—the facets are each formed from the same material. Typically, the facets are planar so that the device can be folded into a flat form when disassembled.

The blank may comprise facets other than side facets and the optional top facet, an example being a bottom facet. However, the inventors have found that, in general, sufficient rigidity and support can be imparted to the marker device in its assembled form by using a blank comprising side facets only, or side facets and a top facet only. Thus, a bottom facet is not a required feature. Indeed, for simplicity of construction and ease of folding once disassembled, the blank preferably does not comprise a bottom facet. More preferably, the plurality of facets consists of n side facets (where n≧3), or the plurality of facets consists of n side facets (where n≧3) and a top facet.

The facets can comprise any suitable natural or synthetic material or materials, or a combination of natural and synthetic materials. Suitable materials include wood, paper, natural or synthetic fabrics, natural or synthetic resins, natural or synthetic polymers, metals, alloys, fibre-reinforced composites, particle-reinforced composites or any combination thereof. Preferably, the marker device is strong, yet light and easy to manoeuvre so that it can be readily assembled and/or folded. Accordingly, preferred materials for the facets include (but are not limited to) expanded polymers, thermoset polymers (such as, for example, acrylic butadiene styrene (ABS)), laminated materials (such as, for example, laminated plastics, plywood and cardboard/paper composites) and fibre-reinforced plastics (such as, for example, fibre-reinforced polyurethane). The thickness of the facet depends on the material used and the size of the device, but is typically 3-6 mm for a square based pyramid device having an assembled base area of about 1 m².

The blank comprises a plurality of facets and fold lines between adjacent facets. The fold lines need to be sufficiently flexible to allow the blank to be assembled into the required three-dimensional pyramid structure, and are also preferably sufficiently flexible to allow the facets to fold back over each other—desirably in both directions—so as to form a flat, folded structure when disassembled.

The fold lines can be constructed in any suitable manner and may comprise, for example, hinges, scores, flexible sheet materials and so on. The inventors have found, however, that whilst traditional mechanical hinges and scores are suitable for forming the required three-dimensional pyramid structure, they tend to restrict motion about the fold and/or allow folding in only one direction. Thus, the blank cannot be folded flat for stowage. These problems can be overcome by providing a fold line comprising a flexible sheet material, said material having sufficient rigidity to prevent the joint between adjacent facets from flexing in an assembled state, yet sufficient flexibility to fold in half about the fold line in either direction. The flexible sheet material can be fixed to the facets on either side of the joint in any suitable way, for example by using adhesives, by means of fasteners such as staples, or—particularly in the case of polymeric materials—by co-extruding the flexible sheet material with a polymeric material comprising the facet.

By thermally reflective material is meant a material which is substantially reflective at thermal infrared wavelengths. By thermal infrared wavelengths is meant infrared wavelengths from about 2 micron to about 20 micron and the terms ‘thermal radiation’ and ‘thermally reflecting’ are construed accordingly. Ideally, the thermally reflecting layer is capable of reflecting thermal radiation in the specific imaging bands 3-5 micron and/or 8-12 micron and advantageously, the reflecting layer is also substantially reflective to wavelengths in the near infrared, that is, wavelengths between about 0.78 micron and about 2 micron. By providing a reflecting layer which is thermally reflective across the near infrared and thermal infrared, a thermal identification panel can be produced which is capable of being viewed in a range of thermal imager and image intensifier devices.

The thermally reflective material desirably has a low emissivity in the thermal infrared and, advantageously, the thermally reflective material is a specular reflector in the thermal infrared waveband having a typical surface roughness below about 0.5 microns. Conveniently, the thermally reflective material has a thermal emissivity less than or equal to 0.5, more preferably less than or equal to 0.3, even more preferably less than or equal to 0.1 and most preferably less than or equal to 0.05. In general, the lower the emissivity in the thermal infrared, the better the performance of the device when viewed through a thermal imager.

The device of the invention preferably comprises a thermally reflective material taking the form of a simple planar reflective layer or coating, wherein the angle of reflection is equal to the angle of incidence. Metals typically have an emissivity in the thermal infrared below 0.1, so advantageously the thermally reflective material is a layer of a metal or metal alloy. In one preferred embodiment, the thermally reflective material is a thin-film metal layer deposited on all or part of the at least two side facets and optional top facet.

Suitable metals include, but are not limited to, gold, platinum, palladium, silver, copper, titanium, chromium, nickel and aluminium, or any combination thereof, or any alloys thereof. Aluminium, nickel, gold and chromium are particularly preferred. Alternatively, the thermally reflective material can be a layer of thermal infrared reflecting paint coated onto all or part of the at least two side facets and optional top facet.

Surfaces such as retro-reflective surfaces are undesirable in the marker device of the invention because radiation is simply reflected along the path of the observer; this limits use in a cold sky reflection device. In general, it is desirable that the thermally reflective surface provides a path of incidence which is different to the path of reflection for the thermal radiation. However, this need not be achieved using a planar surface. In one alternative embodiment of the invention, the infrared reflective material can be a reflective material which possesses an inherent thermal infrared radiation rotation angle, thereby exhibiting an angle of reflection which is different from the angle of incidence. For example, WO 2009/112810 (which is hereby incorporated by reference) discloses a sheet material having a microstructure comprising a plurality of thermally reflective surfaces inclined at an angle θ (0°<θ<90°) to the plane of the sheet material, which material can be used as a cold sky reflector for vertical surfaces. By incorporating the material of WO 2009/112810 into the present invention (typically in the opposite orientation to the mode of use on vertical surfaces) the side facets can be positioned at a more shallow angle than for a simple thermally reflecting surface, whilst still providing the required thermal reflection angles in the device. In other words, a device can be constructed which has optimum reflection angles, but a lower profile than if simple metal coatings or thermally reflective paints were used as the thermally reflective material. One suitable material is Mirage®-V supplied by QinetiQ Limited, UK.

Optionally, one or more of the side facets, and/or the optional top facet, and/or any other facet comprising the plurality of facets, can be coloured. Colour can be imparted in any suitable way. If the facet is required to be thermally reflecting, one way is to use a thermally reflective material which is itself coloured such as, for example, a coating of coloured metal or metal alloy, or a reflective sheet material comprising a coloured metal or metal alloy. Alternatively, a coloured, high thermal reflectivity paint may be used (see, for example, WO 2005/007754), or a thermally transparent coloured material may be applied on top of the thermally reflective material. Clearly, care must be taken that the thermal reflection properties of an underlying thermally reflective layer are not adversely affected by applying a thermally opaque coloured layer.

The object of imparting colour to the device may be to produce a high visibility effect or a camouflage effect. In one preferred embodiment of the invention, one side of the marker device is thermally reflective and camouflaged, and the other side of the device is thermally reflective and highly visible. This can be achieved by one side of the blank comprising a thermally reflective material and a camouflage coating, and the other side of the device comprising a thermally reflective material and a high visibility coating. By incorporating reversible mutual attachment means into the at least one pair of mutually engageable side facets, the device can become a reversible device which has a thermal signature whichever way it is assembled, but can be either conspicuous or inconspicuous—as required—in the visible spectrum. Clearly, top facet fastening means—if present—are also desirably reversible.

The thermally reflective material can cover the whole or part of the facet. In some applications, the thermally reflective material can take the form of a recognisable shape or pattern, albeit at the possible expense of overall reflection efficiency. Similarly, the optional coloured region can cover whole or part of one or more facets, and may be a particular shape or pattern. The shape or pattern of the thermally reflective material may be different to the shape or pattern imparted by the coloured layer.

One suitable thermally reflective material is Mirage® (supplied by QinetiQ Limited, UK). The Mirage® material, which is disclosed in WO 2005/098097 (hereby incorporated by reference), is a thin film sheet material comprising a release paper, a pressure sensitive adhesive, an optional polymer film substrate layer, a reflector layer (typically thin film aluminium) and a thermal infrared radiation transmissive coloured layer such as a thin dyed or pigmented acrylic or olefin polymer. The coloured layer can be camouflaged or high visibility. In use, the release layer is removed and the Mirage material is adhered to a surface to provide a visually coloured thermally reflective coating. Mirage® sheet material, or a sheet material with a similar structure can be positioned on the facets to form a thermally reflective layer.

As mentioned above, in order to achieve optimum conspicuity, it is desirable that the cold sky near the zenith is reflected into a thermal imaging device. If the side facets comprise a simple thermally reflective layer, said facets preferably make an angle (the ‘inclination angle’) of 15° to 60° to a plane parallel with the base of the pyramid, more preferably 20° to 50°, even more preferably 25° to 35° and most preferably about 30°. Should the side facets need to be conspicuous only for ground-to-ground observation, then the inclination angle is desirably about 45°, but if near-horizon observation is required then the inclination angle is preferably about 30°. As a general principle, a smaller inclination angle leads to a larger base area for the marker device (which can be undesirable) whereas inclination angles greater than about 60° tend to reduce the intensity of the cold sky reflection (that is, the intensity of the reflected signal). Lower inclination angles tend to reduce profile height and lower wind resistance. Accordingly, the precise angle chosen will depend on the particular application.

The device is conspicuous in the thermal infrared from a range of viewing angles and, although one or more facets may be shadowed from certain angles, the device generally presents at least one cold facet to the user. Advantageously, the most preferred inclination angle of about 30° can provide cold sky reflection to an air-to-ground observer from the optional top facet as well as one or more of the side facets.

In use, the device is typically mounted on a horizontal surface. Thus, the plane parallel with the base of the pyramid is typically the horizontal plane and the above-mentioned angles are typically angles to the horizontal.

If the side facets comprise a material having an inherent angle of rotation, said facets preferably have an effective angle (that is, the angle of inclination less the angle of rotation) of 15° to 60° to the horizontal, more preferably 20° to 50° and even more preferably about 30°. Again, should the side facets need to be conspicuous only for ground-to-ground observation, then the angle is desirably about 45°, but if near horizon observation is required then the angle is preferably about 30°.

The side facets are likely to have a triangle (preferably an isosceles triangle) shape for a pyramid, or a trapezium (preferably an isosceles trapezium) shape for a truncated pyramid. In either case, angles θ₁ and θ₂ will be formed between the base of the side facet and the edges adjacent said base. θ₁ and θ₂ may be different, but are preferably substantially the same so as to form a regular shaped pyramid. Angles θ₁ and θ₂ may take any angle between 0° and 90°, but are preferably selected so as to provide the required inclination angle once the device is assembled. The skilled person will be aware that, for a particular inclination angle and number of facets, angles θ₁ and θ₂ can be calculated from standard geometric principles. For a regular square-based pyramid having an inclination angle of 30° and comprising a layer of simple reflective material, θ₁=θ₂=49°.

As discussed above, the marker device of the invention is primarily designed to be used in an assembled form (that is, with the at least one pair of mutually engageable side facets engaged using the mutual attachment means, so as to form a three-dimensional pyramid structure). However, the device can also be used in a collapsed form, such that the blank provides a flat panel which can be positioned on a horizontal surface.

The mutual attachment means are required to connect at least one pair of mutually engageable side facets together so as to form the pyramid structure. Accordingly, the mutual attachment means are typically positioned at the edges of the mutually engageable side facets which are separated when the blank is in its disassembled, net shape form. In the case of a truncated pyramid, the mutual attachment means are preferably positioned at lateral edges of the at least one pair of mutually engageable side facets.

The mutual attachment means can be any suitable fastener, and can be a single fastener or a plurality of fasteners. Preferably, the mutual attachment means is selected from the group consisting of zips, press studs, snap fasteners, tab and slot fasteners, hook and loop fasteners, buttons, buckles and eyelets. Zips, hook and loop fasteners and snap lock fasteners tend to be more preferred because of their ease and speed of use. In one preferred embodiment, the mutual attachment means takes the form of a strip of material having fasteners on the underside and reciprocal fasteners positioned on the lateral edges of the mutually engageable side facets. In use, the strip is positioned over the lateral edges to lock the mutually engageable side facets in place.

In a particularly beneficial arrangement, the mutual attachment means is reversible so that it can be fastened from either side of the foldable blank. This provides the advantage that the marker device itself can be assembled with either side outermost, so as to produce the preferred reversible device mentioned above. Examples of reversible attachment means are reversible zips and hook and loop fasteners.

In a particularly preferred embodiment of the invention, the blank is capable of forming a truncated pyramid, adjacent side facets are joined together consecutively at their lateral edges and there is one pair of mutually engageable side facets. (By adjacent side facets is meant side facets that are joined together in the blank.) A blank of this form possesses only one attachment point and accordingly, is easy to assemble into a truncated pyramid. Moreover, if the side facets are substantially the same size and shape, the blank can be folded—by means of a zig-zag fold—into a compact form wherein the side facets lie on top of each other.

In the preferred embodiment, the top facet—if present—is preferably attached by one fold line to the top edge of a side facet, and more preferably attached by one fold line to one of the mutually engageable side facets. Attaching the top facet by one fold line to one of the mutually engageable side facets provides the advantage that the top facet is either the first or last facet to be folded when the disassembled device is folded for stowage. Moreover, in this more preferred configuration, there is only a single seam so that—if required—a single attachment means can be positioned around the perimeter of the top facet and between the mutually engageable side facets. In other words, the mutual attachment means and the top facet fastening means may together form a single fastener, preferably a zip fastener or hook and loop fastener, thereby providing the advantage of rapid and simple assembly. Conveniently, the length of the top facet in a direction perpendicular to the fold line—whether attached to any of the side facets or one of the mutually engageable side facets—is substantially the same as the distance between the bottom edge and top edge of the side facets. This provides the advantage that, when the device of the preferred embodiment is disassembled and subsequently folded, the top facet does not project from the folded structure.

In use, the marker device of the invention is assembled by folding the blank into shape and then engaging the one or more pairs of mutually engageable side facets. The device is then mounted onto an object (such as, for example, a vehicle or building), preferably on a horizontal surface thereof, or near an object, again preferably on a horizontal surface. Preferably, the device additionally comprises means for fixing the device directly to an object. Suitable fixings include ropes, tapes and elastic cords.

Alternatively, the marker device can be mounted onto an object using a mounting frame, preferably a mounting frame which is already fixed to the object. This provides several advantages over mounting the device directly onto the object. For example, the frame can be fixed in a position which provides optimum conspicuity, the frame comprises defined attachment points for the device, and mounting is quick and easy. The frame typically comprises a substrate having substantially the same shape as, and a similar size to, the base of the marker device and a plurality of fixing points. Generally—but not necessarily—the number of fixing points is the same as the number of corners of the marker device and the fixing points are at the corners of the frame. Conveniently, the corners of the marker device are fixed to the corners of the frame using, for example, snap fasteners.

The substrate may be rigid or flexible, but is preferably flexible so as to accommodate slightly non-planar surfaces on which the device may need to be mounted. Preferably, the fixing points comprise adjustable fixing means (such as adjustable snap fasteners) so that the marker device can be fixed to the mount horizontally even if the frame is slightly non-planar. Suitable flexible substrates include polymers and fabrics.

Clearly, if a mounting frame is used, the marker device can comprise means for fixing the device to the frame.

The inventors have found that the performance of the marker device can be compromised, in use, by gusts of wind underneath the device. Accordingly, a seal is preferably made between the bottom rim of the device and the surface of the object on which it is mounted. One way of forming the seal is to provide a material around all or part of the bottom rim (that is, around the bottom edge of the side facets) which can be compressed against the surface when the device is mounted to form a seal. Suitable materials include polymer sealing strips or expanded polymers. Such an approach is suitable when the device is directly mounted onto the object. Alternatively, if a mounting frame is used, one or more flaps of material can be provided around all or part of the bottom rim of the device which can be sealed (preferably by means of a hook and loop fastener) onto the frame once the device has been fixed in place. The one or more flaps can instead be provided on all or part of the mounting frame and sealed onto the device, or flaps can be provided on the device and mounting frame. In all cases, a seal is preferably made between the frame and the device. Advantageously, the flaps can also help to secure the device to the mounting frame.

The marker device of the invention can be produced in a range of sizes, the precise size depending on the particular application and/or the size of the object to be marked.

Typically, the base edge length of an assembled device taking the form of a square based pyramid (excluding the optional mounting frame) lies in the range 0.04 m to 3 m, more preferably 0.09 m to 2.25 m and most preferably 0.09 m to 1.44 m. This approximately corresponds to base areas in the range 0.002 m² to 9 m², more preferably in the range 0.01 m² to 5 m² and most preferably in the range 0.01 m² to 2 m². In one preferred embodiment, the inventors have made a device having an base edge length of 1.4 m, corresponding to a base area of 1.96 m².

According to a second aspect of the invention, there is provided an infrared marker device taking the form of a hollow pyramid structure comprising n side facets (where n≧3) and fold lines between adjacent side facets, wherein two or more side facets comprise a thermally reflective material and wherein at least one pair of side facets are held in place by mutual attachment means and wherein, upon disengagement of the mutual attachment means, the device can be unfolded at the fold lines to form a flat structure.

According to a third aspect of the invention, there is provided an infrared marker device taking the form of a truncated pyramid, preferably a hollow truncated pyramid, said device comprising n side facets (where n≧3) and a top facet, wherein two or more side facets comprise a thermally reflective material. Preferably, all of the side facets comprise a thermally reflective material. The top facet can also comprise a thermally reflective material. In the most preferred form, all of the side facets and the top facet comprise a thermally reflective material so as to provide an uninterrupted hemispherical detection arc. Optimum conspicuity is provided when n=3, n=4 or n=5.

The device of the third aspect may take the form of a foldable blank as discussed above in relation to the first aspect. Alternatively, the side facets and/or top facet may be individually engageable with each other using attachment means such as those described in relation to the first aspect. Accordingly, the invention also extends to a kit of parts for a thermal identification device comprising n side facets (where n≧3) and a top facet, wherein two or more side facets comprise a thermally reflective material.

Preferred inclination angles for the third aspect are as described in relation to the first aspect.

According to a fourth aspect of the invention, there is provided an infrared marker system comprising an infrared marker device as described above and a frame for mounting the device onto an object. A suitable frame has been discussed above in relation to the first aspect.

According to a fifth aspect of the invention, there is provided a method of marking an object, said method comprising the steps of:
providing an infrared marker device taking the form of a foldable blank comprising a plurality of facets and fold lines between adjacent facets, said blank being capable of forming a hollow pyramid structure, wherein the plurality of facets includes n side facets (where n≧3) and wherein at least one pair of mutually engageable side facets comprise mutual attachment means so that the pyramid structure can be formed and wherein two or more side facets comprise a thermally reflective material;
assembling the marker device into a three-dimensional pyramid and engaging the mutually attachable side facets using the mutual attachment means; and
positioning the assembled marker device on or near the object.

Preferably the device is mounted onto a substantially horizontal surface. Conveniently, the marker is positioned on or near the object by means of a mounting frame. The object may be any object, such as, for example, a vehicle, building or even terrain.

According to a sixth aspect of the invention, there is provided the use of a foldable blank comprising a plurality of facets and fold lines between adjacent facets, said blank being capable of forming a hollow pyramid structure, wherein the plurality of facets includes n side facets (where n≧3) and wherein at least one pair of mutually engageable side facets comprise mutual attachment means so that the pyramid structure can be formed and wherein two or more side facets comprise a thermally reflective material, as a thermal infrared marker device.

According to a seventh aspect of the invention, there is provided a method of marking an object, said method comprising the steps of:
providing a thermal infrared marker device according to the third aspect; and
positioning the assembled marker device on or near the object.

Any feature in one aspect of the invention may be applied to any other aspects of the invention, in any appropriate combination. In particular, device aspects may be applied to method aspects, and vice versa.

The invention will now be described with reference to the accompanying drawings in which;

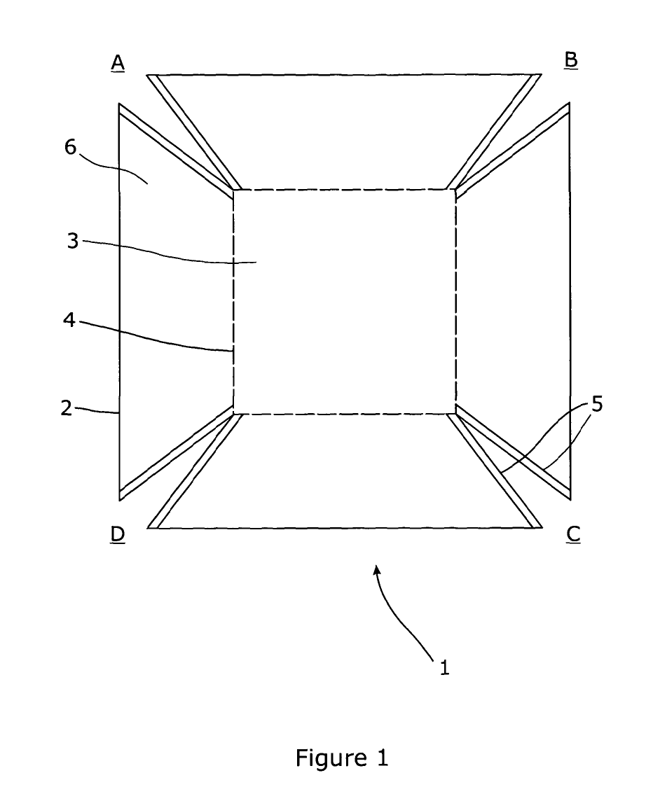

FIG. 1 is a schematic, top-down view of one embodiment of an infrared marker according to the invention in its disassembled form;

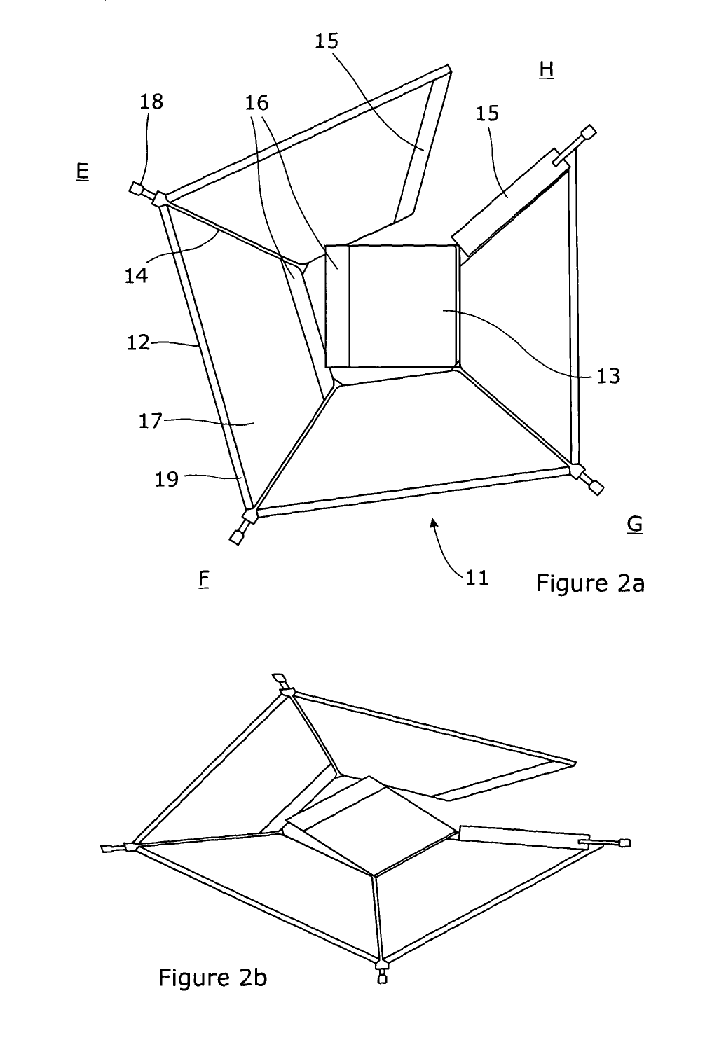

FIGS. 2a and 2b are, respectively, schematic top-down and sideways elevational views of another, preferred embodiment of the invention in its disassembled form;

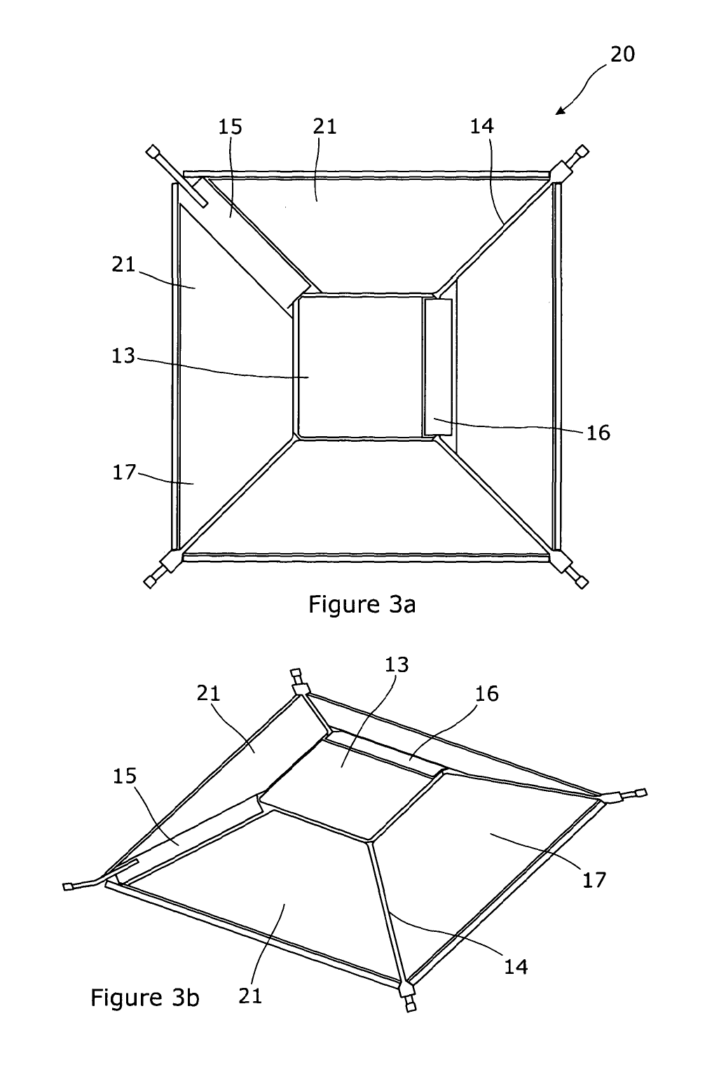

FIGS. 3a and 3b are, respectively, schematic top-down and sideways elevational views of the preferred infrared marker in its assembled form;

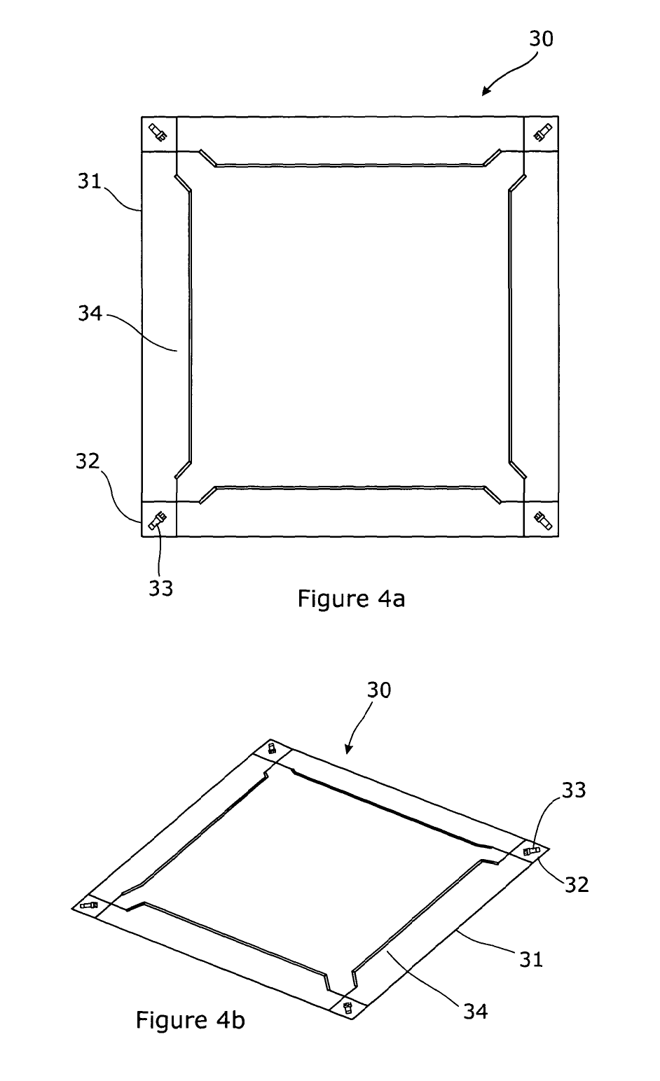

FIGS. 4a and 4b are, respectively, schematic top-down and sideways elevational views of a mounting frame suitable for the preferred infrared marker device;

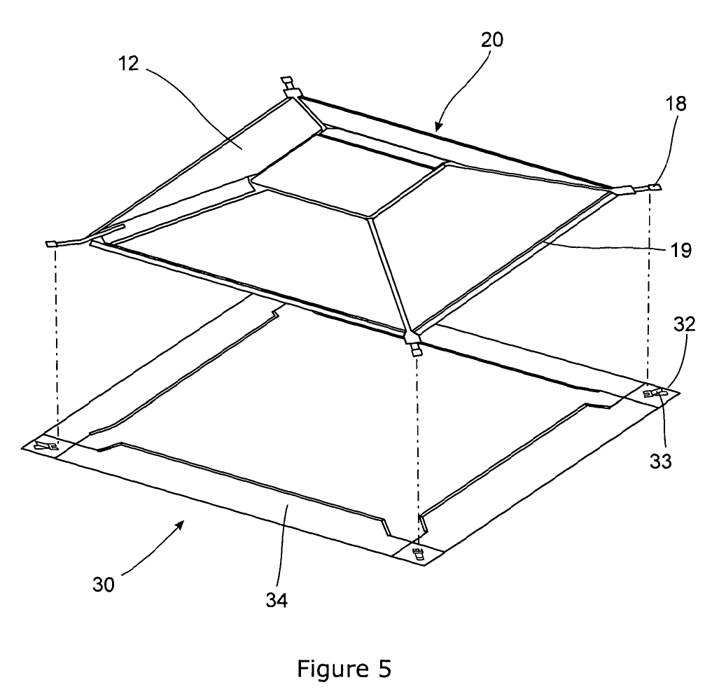

FIG. 5 is an exploded, sideways elevational view of the preferred infrared marker device positioned on the mounting frame;

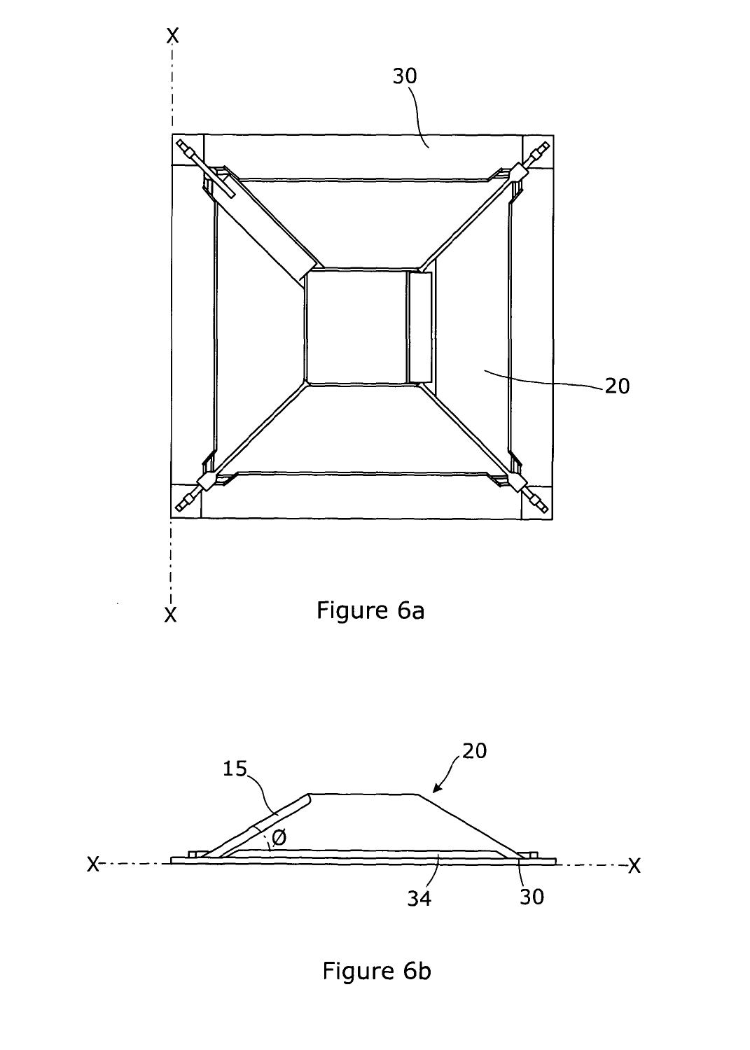

FIGS. 6a and 6b are, respectively, schematic top-down and sideways views of the preferred infrared marker device positioned on the mounting frame;

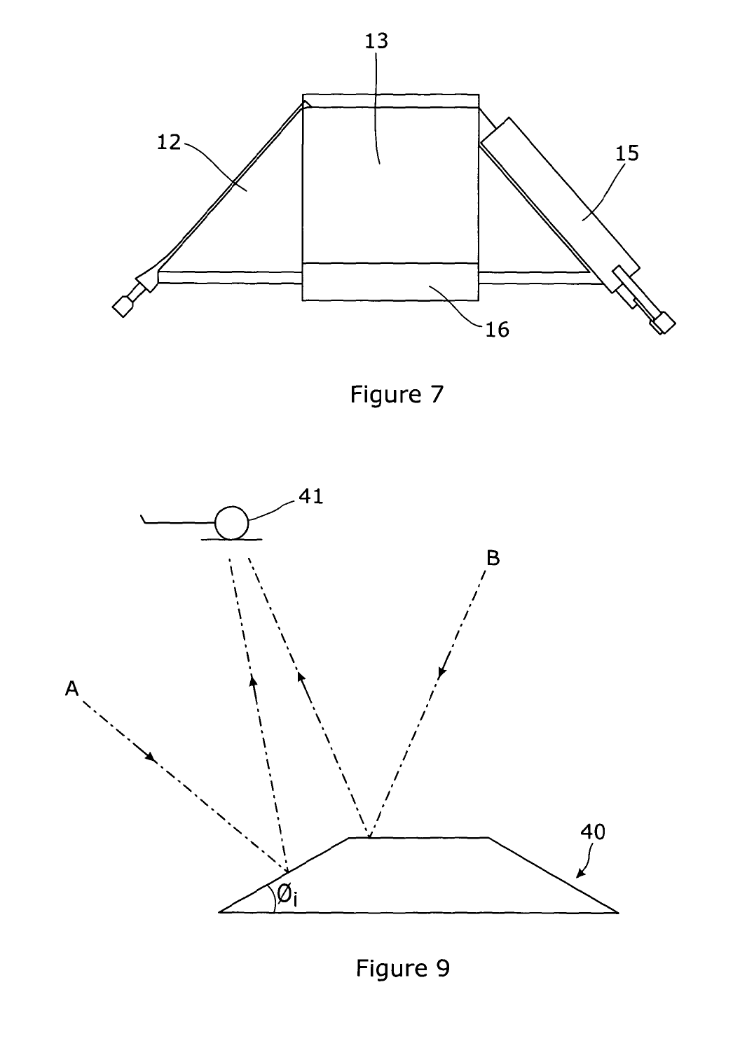

FIG. 7 is a schematic, top-down view of the preferred marker device, disassembled and folded for storage;

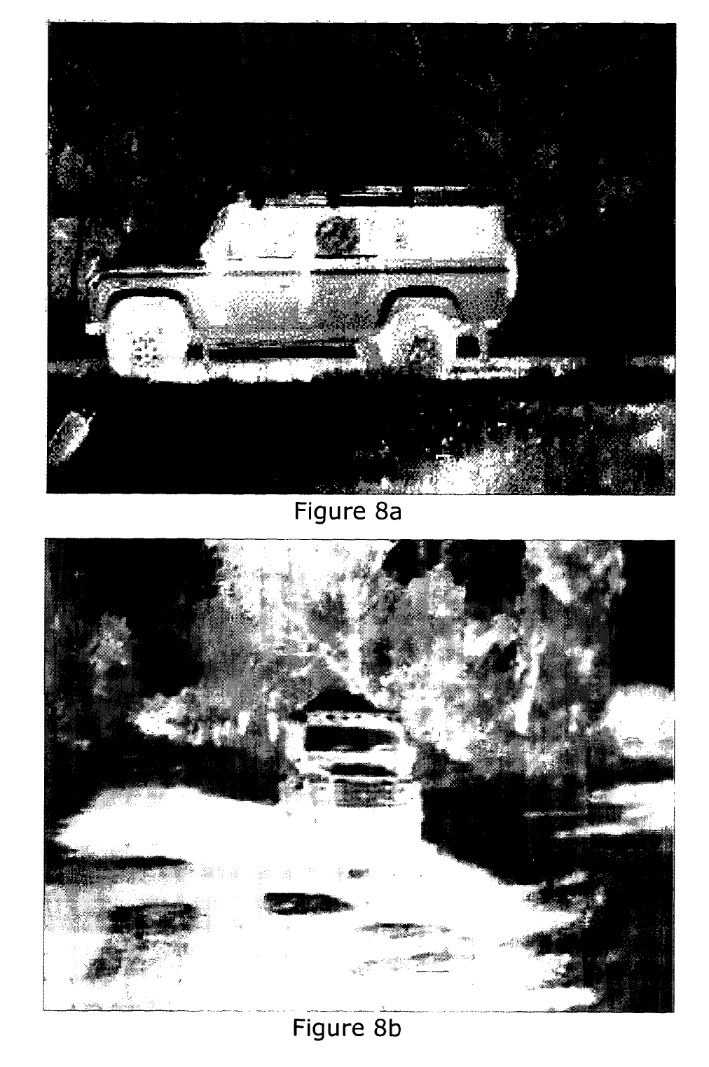

FIGS. 8a and 8b are 8-12 micron thermal images of an infrared marker device according to the invention positioned on a vehicle; and

FIG. 9 is a schematic representation of a thermal marker device in use.

FIG. 1 is a schematic, top-down view of one possible infrared marker according to the invention, in its disassembled form. The marker 1 takes the form of a foldable blank capable of forming a square based truncated pyramid, the blank comprising four side facets 2, a top facet 3 and fold lines 4 between adjacent facets. In this embodiment, the device comprises four pairs of mutually engageable side facets and mutual attachment means 5 are positioned at the lateral edges of each side facet. The side facets 2 and the top facet 3 each comprise a thermally reflective material 6. In use, the blank is folded at the fold lines to form a pyramid structure with the thermally reflective material 6 outermost, and the side facets are engaged at points A, B, C and D.

FIGS. 2a and 2b illustrate another, preferred embodiment of the invention in its disassembled form. FIG. 2a is schematic, top-down view of the infrared marker device 11 taking the form of a foldable blank capable of forming a truncated square based pyramid, the blank comprising four side facets 12 and a top facet 13. The lateral edges of the side facets at corners E, F and G are joined by means of fold lines 14, whereas the lateral edges of the side facets at corner H remain open. Thus, the side facets adjacent to corner H are a pair of mutually engageable side facets comprising mutual attachment means 15. The top facet 13 is joined to one of the mutually engageable side facets by means of another fold line and comprises top facet fastening means 16. The side facets 12 and the top facet 13 each comprise a thermally reflective material 17. In use, the device is folded about the fold lines 14 to produce a three-dimensional pyramid structure having four sides formed by side facets 12 and capped by top facet 13, with the thermally reflective material 17 outermost. The pyramid structure is secured by mutual attachment means 15 and the top facet is held in place by top facet fastening means 16. The device also comprises fasteners 18 which can be used to secure the device to the object to be marked.

In the particular embodiment illustrated, the fasteners 18 are snap lock fasteners which can be connected to corresponding fasteners 33 on a mounting frame 30 (see FIGS. 4a and 4b) and the mutual attachment means 15 and top facet fastening means 16 are fabric strips comprising hook and loop fasteners. The fold lines 14 are formed from a flexible sheet material secured to the underside of the side and/or top facets and the device additionally comprises a perimeter fastener 19 around the base perimeter which can be engaged with flaps 34 on the mounting frame (see FIGS. 4a and 4b).

FIGS. 3a and 3b are, respectively, schematic top-down and sideways elevational views of infrared marker device 11 in its assembled form (assembled marker device 20). The blank has been folded about fold lines 14 so as to form a square based pyramid structure. Mutually engageable side facets 21 are fixed in place by mutual attachment means 15 and the top facet 13 is fixed in place by top facet fastening means 16. Thermally reflective material 17 faces outwards from the device.

FIGS. 4a and 4b are, respectively, schematic top-down and sideways elevational views of a mounting frame suitable for the assembled marker device 20. Mounting frame 30 comprises a substantially square, planar substrate 31 having four corners. Fixing points 32 are provided at the four corners, in this particular case comprising snap fasteners 33. The frame additionally comprises four flaps 34 for providing a seal between the frame 30 and assembled marker device 20 once mounted. A suitable fastener, such as, for example, press studs or a hook and loop fastener, is provided on the underside of flaps 34 (not visible).

Mounting frame 30 can be secured to the object in any suitable way, such as by means of an adhesive, bolts or rivets. Optionally, the mounting frame can be secured to the object in a removable manner.

FIG. 5 is an exploded, sideways elevational view of marker device 20 positioned on mounting frame 30. The corners of the marker device are located at fixing points 32 and fixed in place by snap lock fasteners 33 and 18. Sealing flaps 34 are positioned over side facets 12 and secured in place by perimeter fastening means 19.

FIG. 6a is a schematic, top-down view of marker device 20 mounted on mounting frame 30 and FIG. 6b is a sideways view of the mounted marker device showing marker device 20, mounting frame 30, mutual attachment means 15 and sealing flap 34. Angle θ is 30°.

FIG. 7 is a schematic, top-down view of disassembled marker device 11 folded for storage. Side facets 12 have been folded respectively over each other in a zig-zag fashion, with top facet 13 as the final fold. The stacked side facets 12, top facet 13, mutual attachment means 15 and top facet fastening means 16 form a compact folded unit for storage.

FIGS. 8a and 8b are 8-12 micron thermal images of an infrared marker device according to the invention positioned on a vehicle. The device appears as a distinct dark (cold) spot in the thermal imager.

FIG. 9 is a sideways view of a thermal marker device according to the invention on a horizontal surface, in use by a aircraft positioned close to the zenith. The thermal infrared marker device 40 has an inclination angle θᵢ of 30° and thermally reflective top and side facets. Cold sky having an elevation of about 40° above the horizon is reflected from the side facet along path A to helicopter 41 and colder sky close to the zenith is reflected from the top facet along path B. As a result, the thermal marker reflects sky from the top facet as well as one or more side facets and is highly conspicuous.

For an aircraft such as a fast jet approaching at a lower angle (typically between 2 and 20° from the horizon) only the facet facing the aircraft is likely to reflect cold sky. However, the device is still conspicuous in the thermal infrared. In general, an aircraft, vehicle, person and so on approaching from any angle will observe cold sky reflection from the device.

It will be understood that the present invention has been described above purely by way of example, and modification of detail can be made within the scope of the invention. Each feature disclosed in the description, and (where appropriate) the claims and drawings may be provided independently or in any appropriate combination.

It will also be understood that ‘infrared marker device’ and ‘infrared device’ as used above is generally intended to mean a ‘thermal infrared marker’, that is a marker device which can be observed in the thermal infrared. Such devices have particular utility in military applications.

Although the invention has been described with specific reference to thermal infrared markers for military applications, it will be understood that this is not intended to be limiting and the invention may be used more generally in application where a thermally reflective marker is desirable, examples being in the fields of security and/or policing operations. In some applications, the marker may be used as a terrain marker.

1. A thermal infrared marker device taking the form of a foldable blank comprising a plurality of facets and fold lines between adjacent facets, said blank being capable of forming a hollow pyramid structure, wherein the plurality of facets includes n side facets (where n≧3) and wherein at least one pair of mutually engageable side facets comprise mutual attachment means so that the pyramid structure can be formed and wherein two or more side facets comprise a thermally reflective material.

2. An infrared marker device according to claim 1, wherein the pyramid structure is a truncated pyramid and the side facets each comprise a top edge, a bottom edge and two lateral edges.

3. An infrared marker device according to claim 2, wherein the mutual attachment means are positioned at lateral edges of the at least one pair of mutually engageable side facets.

4. An infrared marker device according to claim 2, wherein adjacent side facets are joined together consecutively at their lateral edges and there is one pair of mutually engageable side facets.

5. An infrared marker device according to 4 claim 2, wherein the blank additionally comprises a top facet.

6. An infrared marker device according to claim 5, wherein the top facet comprises a thermally reflective material.

7. An infrared marker device according to claim 5, wherein the top facet is attached by one fold line to the top edge of one of the mutually engageable side facets

8. An infrared marker device according to claim 7, wherein the length of the top facet in a direction perpendicular to the fold line is substantially the same as the distance between the bottom edge and side edge of the side facet.

9. An infrared marker device according to claim 5, wherein top facet fastening means are provided on some or all of the top edges of the side facets and/or the edge of the top facet so as to secure the top facet in place.

10. An infrared marker device according to claim 9, wherein the top facet fastening means is selected from the group consisting of zips, press studs, snap fasteners, hook and loop fasteners, eyelets, buttons and buckles.

11. An infrared marker device according to claim 10, wherein the fastening means and attachment means together comprise a single zip fastener provided around the top facet and detachable joint.

12. An infrared marker device according to claim 1, wherein all of the side facets comprise a thermally reflective material.

13. An infrared marker device according to claim 1, wherein the side facets are substantially the same size and shape.

14. An infrared marker device according to claim 1, wherein n=4 and the blank is capable of forming a truncated square based pyramid or a truncated rectangle based pyramid.

15. An infrared marker device according to claim 1, wherein the mutual attachment means is selected from the group consisting of zips, press studs, snap fasteners, hook and loop fasteners, eyelets, buttons and buckles.

16. An infrared marker device according to claim 1 wherein the mutual attachment means is reversible.

17. An infrared marker device according to claim 1, wherein the fold lines are reversible so that the blank can be folded to form a flat structure.

18. A marker device according to claim 1, wherein the fold lines comprise a flexible sheet material.

19. A marker device according to claim 1, wherein shape of the facet is selected so as to provide an inclination angle of 20° to 60°.

20. An infrared marker device according to claim 1, additionally comprising means for fixing said device to an object.

21. A thermal infrared marker device taking the form of a hollow pyramid structure comprising n side facets (where n≧3) and fold lines between adjacent side facets, wherein two or more side facets comprise a thermally reflective material and wherein at least one pair of side facets are held in place by mutual attachment means and wherein, upon disengagement of the mutual attachment means, the device can be unfolded at the fold lines to form a flat structure.

22. A thermal infrared marker device taking the form of a truncated pyramid, preferably a hollow truncated pyramid, said device comprising n side facets (where n≧3) and a top facet, wherein two or more side facets comprise a thermally reflective material.

23. A thermal infrared marker system comprising an infrared marker device according to claim 1 and a frame for mounting the device onto an object.

24. A method of marking an object with a thermal infrared signature, said method comprising the steps of:
providing a thermal infrared marker device taking the form of a foldable blank comprising a plurality of facets and fold lines between adjacent facets, said blank being capable of forming a hollow pyramid structure, wherein the plurality of facets includes n side facets (where n≧3) and wherein at least one pair of mutually engageable side facets comprise mutual attachment means so that the pyramid structure can be formed and wherein two or more side facets comprise a thermally reflective material;
assembling the marker device into a three-dimensional pyramid and engaging the mutually attachable side facets using the mutual attachment means; and
positioning the assembled marker device on the object.

25. A method according to claim 24, wherein the assembled marker is positioned on a substantially horizontal surface.

26. A method according to claim 24, wherein the marker is positioned on the object by means of a mounting frame.

27-29. (canceled)
